(19) United States
(12) Patent Application Publication
(10) Pub. No.: US 2015/0074795 A1
(43) Pub. Date: Mar. 12, 2015

(54) ONE-TIME PASSWORD GENERATION APPARATUS AND METHOD USING VIRTUAL INPUT MEANS

(71) Applicants: Young Man HWANG, Goyang-si (KR); Sung-Min JOO, Seoul (KR)

(72) Inventors: Young Man HWANG, Goyang-si (KR); Sung-Min JOO, Seoul (KR)

(21) Appl. No.: 14/062,248

(22) Filed: Oct. 24, 2013

(30) Foreign Application Priority Data
Sep. 9, 2013 (KR) 10-2013-0107695

(51) Int. Cl. G06F 21/45

(52) U.S. Cl. CPC G06F 21/45
USPC 726/18

(57) ABSTRACT

One-time password (OTP) generation apparatus and method using virtual input means are provided. Reference information generated by a reference information generation unit is compared with identification information. When the reference information is identical to the identification information, a value corresponding to indication information is generated as an OTP.

### CROSS-REFERENCE(S) TO RELATED APPLICATION

This application claims the benefit of Korean Patent Application No. 10-2013-0107695, filed on Sep. 9, 2013, the contents of which are incorporated herein by reference.

### BACKGROUND OF THE INVENTION

1. Field of the Invention

The present invention relates to one-time password generation apparatus and method, and more particularly, to one-time password generation apparatus and method using virtual input means, which can achieve user authentication by generating a one-time password allowing a user to input a different password every time by using a terminal.

2. Description of the Related Art

Generally, a user authentication system refers to a system that authenticates a user by inputting identification (ID) and password the user has designated previously.

Such a conventional user authentication system has to authenticate a user by a fixed password. Thus, when a terminal is hacked or a password is exposed to the outside, damages such as leakage of a user's personal information may occur, and a user is inconvenienced by having to change a password periodically.

In addition, a conventional one-time password (OTP) is a user authentication method using an OTP of a random number generated randomly. Since a user has to use an OTP generator (token) which is hardware for generating an OTP, costs for purchasing a separate device are increased, and a user has to carry the OTP generator. As such, the conventional OTP has a problem in that the user cannot easily use the OTP.

Furthermore, a biometrics method for user authentication has a problem that considerable costs are involved in system establishment.

Korean Patent Registration No. 10-1204980 discloses a method and system for one-time password registration and authentication with enhanced randomness, which uses an OTP terminal to generate a one-time password by using a session key, an initial value, and number of times of login, but has a problem in that a separate OTP terminal is required.

According to a user authentication method using a plurality of OTPs, which is disclosed in Korean Patent Registration No. 10-1272349, a smart device registered as a mobile OTP device generates a plurality of OTPs and outputs the OTPs to a display unit one by one. Therefore, it is possible to prevent other's OTP from being stolen. If the OTP is used or a predetermined time has elapsed, the OTP is immediately discarded. In this manner, an authentication method capable of preventing hacking and preventing damages from duplicate connection is used, but a separately registered OTP terminal is required for authentication.

### SUMMARY OF THE INVENTION

The present invention has been made in an effort to solve the above problems, and is directed to provide OTP generation apparatus and method using virtual input means, in which identification information known to only a user is set, an OTP is generated in the OTP generation apparatus according to the set information, and a password is input in a prearranged direction through the virtual input means, so that the user can acquire and input OTP information by using a terminal held by the user, without possessing a separate OTP generator.

The technical problems intended to be achieved by the present invention are not limited to the above-mentioned technical problems, and other technical problems, which are not described herein, will be clearly understood from the following description by those skilled in the art to which the invention pertains.

According to one aspect of the present invention, an OTP generation apparatus for user authentication includes: a reference information generation unit configured to generate reference information; and an OTP generation unit configured to generate a value corresponding to indication information as an OTP when the reference information and identification information are identical to each other. According to another aspect of the present invention, an OTP generation method for user authentication includes: generating reference information by a reference information generation unit; determining whether the reference information and identification information are identical to each other; and generating, by an OTP generation unit, a value corresponding to indication information as an OTP when the reference information and identification information are identical to each other.

### BRIEF DESCRIPTION OF THE DRAWINGS

FIG. 1 is a configuration diagram illustrating an OTP generation apparatus according to the present invention.

FIG. 2 is a flowchart illustrating an embodiment of reference information acquisition of the OTP generation apparatus according to the present invention.

FIG. 3 is a diagram illustrating an embodiment of OTP input using a table and a virtual input means of the OTP generation apparatus according to the present invention.

FIG. 4 is a diagram illustrating an embodiment of a keypad scheme according to the present invention.

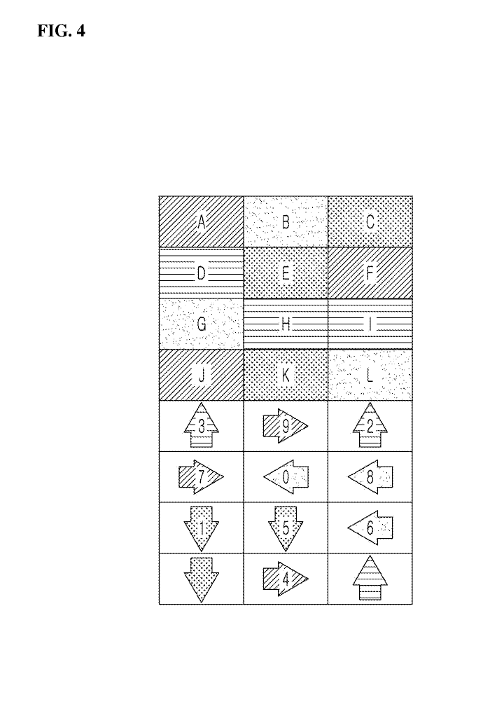

FIG. 5 is a configuration diagram illustrating a terminal according to the present invention.

FIG. 6 is a flowchart illustrating an OTP generation method according to the present invention.

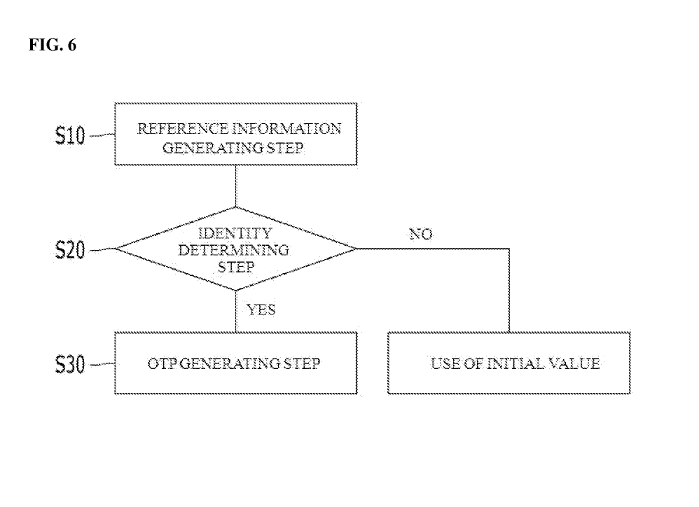

### DESCRIPTION OF REFERENCE NUMERALS

10: OTP generation apparatus
110: Reference information generation unit
111: Table generation unit
130: OTP generation unit
150: Detection unit
170: Virtual input means generation unit
190: Memory unit
200: Terminal
210: Control unit
220: Communication unit
230: Input unit
240: Output unit
250: Data storage unit
260: Interface unit
270: Power supply unit
S10: Reference information generating step
S20: Identity determining step
S30: OTP generating step

### DETAILED DESCRIPTION OF EXEMPLARY EMBODIMENTS

Exemplary embodiments of the present invention will be described below in detail with reference to the accompanying drawings. The size or shape of components illustrated in the drawings may be exaggerated for clarity and convenience of description. Also, the terms may vary depending on users' or operators' intentions or practices. Therefore, the terms used herein must be understood based on the descriptions made herein. The scope of the present invention is not limited to the embodiments set forth herein. Those skilled in the art can easily carry out other embodiments without departing from the scope of the present invention, it is apparent that those embodiments also fall within the scope of the present invention.

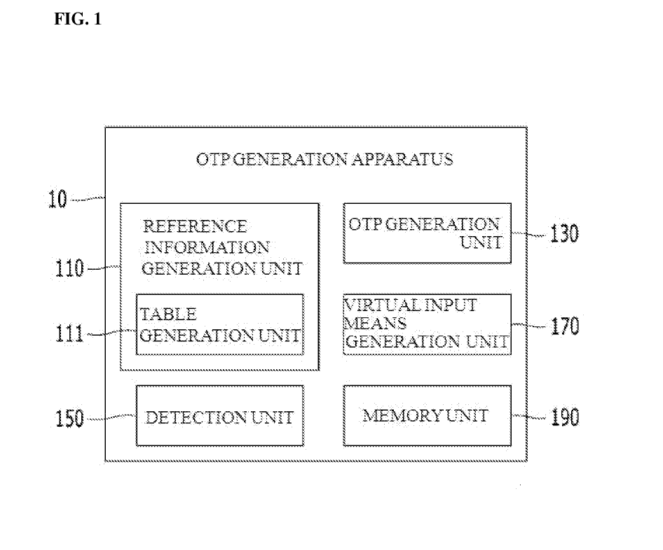

FIG. 1 is a configuration diagram illustrating an OTP generation apparatus 10 according to the present invention. The following description will be made with reference to FIG. 1, and separate reference drawings are indicated to elements which are not illustrated in FIG. 1.

The OTP generation apparatus 10 using virtual input means according to one aspect of the present invention includes a reference information generation unit 110 and an OTP generation unit 130.

The OTP generation apparatus 10 according to one aspect of the present invention may be implemented with software, hardware, or a combination thereof. The OTP generation apparatus 10 compares identification information with reference information generated by the reference information generation unit 110 to be described below. When the reference information and the identification information are identical to each other, the OTP generation unit 130 generates a value corresponding indication information as an OTP. For example, when the reference information and the identification information are identical to each other, the value corresponding to the indication information is generated based on an initial value to be described below. When the reference information and the identification information are not identical to each other, the initial value is generated as the OTP value, and the OTP is generated such that the value corresponding to the indication information and the initial value appear in combination.

When the user recognizes the reference information, the OTP generated by the OTP generation apparatus 10 can be input to the virtual input means to be described below. Therefore, personal information security is enhanced.

The initial value refers to a password previously determined for user authentication, and refers to a password previously stored by a user in a memory unit 190 of a server or a terminal for user authentication in a conventional web site or a program. Specifically, the initial value refers to a password previously determined for user authentication, and refers to a value stored in the memory unit 190 of the server or the terminal.

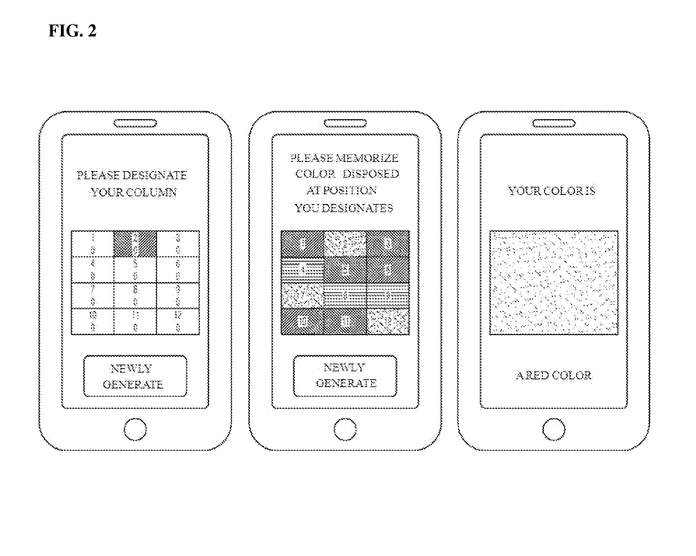

Referring to FIG. 2, the reference information generation unit 110 generates the reference information by the user's designation. Specifically, the reference information is generated from a position, order or other terminal designated by the user. Generation from other terminal means that the reference information is generated from other terminal and is transmitted to the user, so that the user authentication can be achieved by using one or more terminals 200.

The reference information generation unit 110 includes a table generation unit 111 which generates a table of which columns can be designated by the user, and information corresponding to the column of the table designated by the user is generated as the reference information. For example, a table whose columns can be designated by the user is generated, and each reference information of the table is provided. This allows the user to acquire user's unique information and the password is input based on the OTP generated by the OTP generation apparatus 10. Even though the password leaks out, the reference information continuously changes. Therefore, the user can input the password with an easier mind.

The OTP generation unit 130 generates the value corresponding to the indication information as the OTP. Specifically, the OTP generation unit 130 generates the OTP with reference to the initial value.

The identification information is identification information from which the user can analogize the OTP by comparison with the reference information. Specifically, the identification information and the reference information are the same type. In addition, the identification information may be generated in a keyboard of the virtual input means generated in a virtual input means generation unit 170 to be described below.

In another aspect of the present invention, the reference information and the identification information are the same type. That is, the reference information and the identification information are formed as the same information. Specifically, the reference information and the identification information are information of one or more selected from the group consisting of color, sound, symbol, image, and vibration.

For example, in the case of the color, certain colors are arranged in the table generated in the table generation unit 110, and color values are checked. The color values are compared with color values of the virtual input means generated in the virtual input means generation unit 170 to be described below. When the colors are the same, the OTP is input according to a direction mark (indication information) of the virtual input means. In the case of the symbol and the image, like the color, the same symbol and image are compared and the OTP is input. In the case of the sound, a beforehand listening function is added to the virtual input means, so that the user can confirm a sound value of a keyboard of the corresponding virtual input means before inputting. In the case of the same sound as the sound of the position designated by the user in the table, the password is input according to the guide of the direction indication. In the case of the vibration, in a similar manner to the sound method, the user is allowed to previously confirm the vibration in the virtual input means. Thus, the user inputs an OTP after checking a keyboard of the virtual input means vibrating in the same manner as the table of the position designated by the user. This allows the user to compare the reference information with the identification information, and allows the user to input a changed OTP whenever the password is input, thereby enhancing security.

In another aspect of the present invention, four or more pieces of reference information and identification information are provided. For example, four or more colors (e.g., red, blue, green, violet) are arranged in the table. Since this allows only the user to confirm the reference information, it is possible to prevent the user's unique reference information from easily leaking out.

In another aspect of the present invention, the indication information is direction indication information that indicates specific direction. This allows the user to confirm the direction indication information and input an OTP. Specifically, when the reference information and the identification information are identical to each other, an OTP is generated by changing the initial value to a direction value corresponding to the direction indication information.

In another aspect of the present invention, the value corresponding to the indication information is a tilt or shaking value generated by a tilt and shaking detection unit 150 when the OTP generation apparatus 10 is tilted or shaken. The detection unit 150 included in the OTP generation apparatus 10 and detects a value relative to the tilt and shaking of the OTP generation apparatus 10. This forms a variety of indication information, and the indication information can be selected and acquired according to the convenience of the user. The detection unit 150 may be configured with a gyro sensor, an acceleration sensor, or a touch sensor to generate a tilt or shaking value.

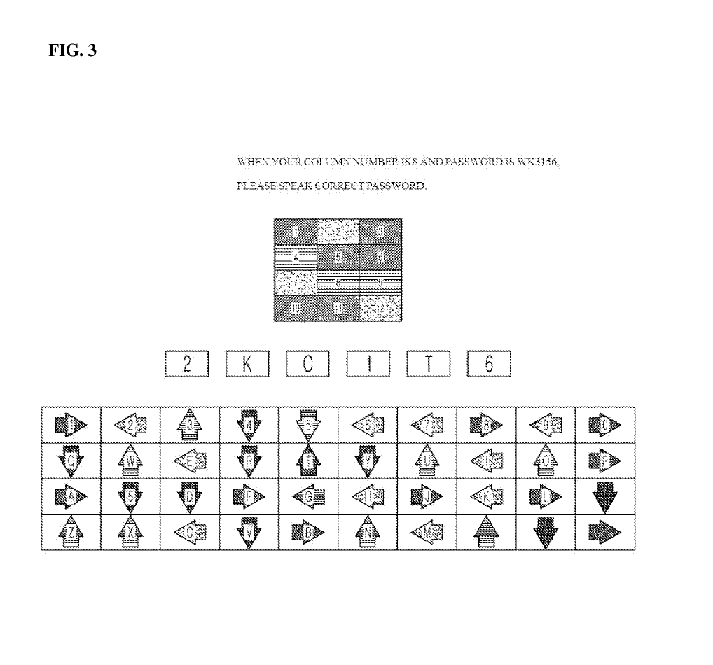

In another aspect of the present invention, referring to FIG. 3, the virtual input means generation unit 170 generates virtual input means. In addition, the generated OTP is input through the virtual input means.

The virtual input means generation unit 170 is included in the OTP generation apparatus 10. More specifically, the indication information and the identification information may be generated in each keyboard of the virtual input means. Therefore, the user is allowed to analogize the OTP by comparing the identification information and the indication information of the virtual input means with reference to the reference information. That is, as a result of comparison with reference to the initial value, when the reference information and the identification information are identical to each other, a value corresponding to the indication information is generated as the OTP value. When not identical, the OTP is generated by using the initial value as it is. In addition, the table generated by the table generation unit 111 and the virtual input means generated by the virtual input means generation unit 170 can be output to the display unit of the OTP generation apparatus 10.

In one embodiment of the present invention, referring to FIG. 3, a position designated by the user is an eighth position of a numeric keyboard, and eighth reference information (color) is a green color. When an initial value password is WK3156, identification information of W of the virtual input means is a green color, and the indication information indicates an upper direction. Thus, the user has only to input a value of 2 instead of W. Regarding the other passwords, as a result of comparison, when the reference information and the identification information are identical to each other, a value corresponding to the indication information indicated by the virtual input means is input. When the reference information and the identification information are not identical to each other, the user inputs the initial value as it is. Therefore, the OTP the user can input using the virtual input means is 2KC1T6. Since the user can variably use the OTP without continuously changing the password, the user can use the OTP simply. In addition, since the user can input the OTP through such a rule, higher security can be obtained.

In another aspect of the present invention, the value corresponding to the indication information is a pattern value, a repetitive input value of a specific value, or a continuous input value of a specific value, each of which is input through the virtual input means. The pattern value allows the user to draw a predetermined pattern by using the virtual input means. The indication information serves as a guide to generate a changed OTP having a nonzero initial value upon generation of the OTP, and allows the user to analogize an OTP by confirming identification information and indication information.

In another aspect of the present invention, the value corresponding to the indication information is a previously determined value. The previously determined value is a value which is previously stored in the memory unit 190 of the OTP generation apparatus 10.

In another aspect of the present invention, the OTP generation apparatus 10 is a server or a user terminal 200. The server refers to an information repository capable of storing information, and the user terminal 200 refers to a terminal such as a computer, a mobile phone, a tablet PC, a notebook computer, and a navigation.

In another aspect of the present invention, the virtual input means is provided with a virtual QWERTY keyboard or a virtual keypad. The virtual QWERTY keyboard refers to the display of an existing computer keyboard on the display unit, and the virtual keypad refers to the display of a mobile phone keyboard on the display unit.

In another aspect of the present invention, the reference information and the identification information are changed at every request for user authentication. That is, the reference information arranged in the table and the identification information arranged in the virtual input means are changed at every request for user authentication, and therefore, the OTP is changed. This flexibly changes the reference information and the identification information without fixing them. Hence, even when the user information leaks out, an OTP having a different value can be continuously provided, thereby enhancing security.

In another aspect of the present invention, the indication information provided in the virtual input means is changed at every request for user authentication. That is, since a different OTP is generated by changing indication information at every time, security is enhanced.

In another aspect of the present invention, when incorrect OTPs are input three or more times, the reference information, the indication reference, and the identification information are changed. When the incorrect password is input, another OTP is automatically generated, thereby achieving safer user authentication.

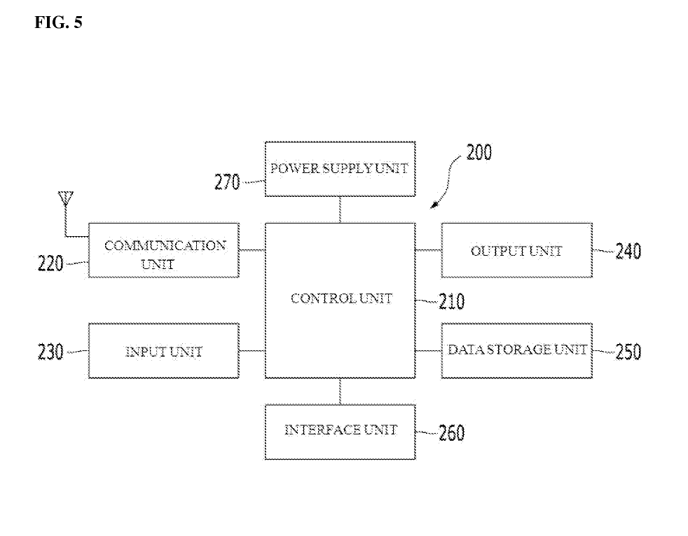

Referring to FIG. 5, the user terminal 200 may include a mobile phone, a smart phone, a laptop computer, a digital broadcasting terminal, a personal digital assistant (PDA), a portable multimedia player (PMP), and a navigation in a mobile terminal, a terminal, or a portable terminal. However, it is obvious to those skilled in the art that the configuration according to the embodiment described in the present specification can also be applied to a stationary terminal, such as a digital TV or a desktop computer, as well as the terminal.

The terminal 200 includes a control unit 210, a communication unit 220, an input unit 230, an output unit 240, a data storage unit 250, an interface unit 260, and a power supply unit 270.

The control unit 210 performs an overall control of the terminal 200. For example, the control unit 210 performs control and processing related to the input/output of OTP information received from the communication unit 220.

The communication unit 220 may include one or more modules that enable wireless communication between the terminal 200 and a user DB or between the terminal 200 and a network where the terminal 200 is located. The communication unit 220 transmits and receives wired/wireless signals. The wired signal may include a voice call signal, a video call signal, or various types of data according to text/multimedia message transmission/reception. The communication unit 220 can also transmit and receive a control command that can control the OTP generation apparatus using the virtual input means. The communication unit 220 uses a near field communication technology. Specifically, the communication unit 220 uses one selected from the group consisting of Wireless-Fidelity (WiFi), Bluetooth, Radio Frequency IDentification (RFID), and an infrared Data Association (IrDA). In addition, the communication unit 220 may include a broadcasting reception module, a mobile communication module, and a position information module.

The input unit 230 generates input data that allows the user to control the operation of the terminal 200. In addition, the input unit 230 can generate input data for input of the OTP. According to the present invention, the input unit 230 can receive a signal designating two or more of displayed contents from the user. The signal designating two or more contents can be received through a touch input or may be received through hard key and soft key input. The input unit 230 can receive the input of selecting one content or two or more contents from the user. In addition, an input of generating an icon related to a function the terminal 200 can perform can be received from the user. As such, the input unit 230 can be configured with a navigation key, a keypad, a dome switch, a touch pad (constant voltage/electrostatic), a jog wheel, and a jog switch.

The output unit 240 generates an output related to a sense of vision, a sense of hearing, or a sense of touch. Accordingly, the output unit 240 may include a display unit, a sound output module, an alarm unit, and a haptic module.

The display unit displays (outputs) information processed in the terminal 200. For example, in case where the terminal 200 receives OTP-related information, the display unit displays an OTP-related user interface (UI) or graphic user interface (GUI). In addition, the display unit according to the present invention supports 2D and 3D display modes. That is, the display unit according to the present invention may have a configuration that combines a general display device with a switch liquid crystal. A traveling direction of light is controlled by operating optical parallax barrier using the switch liquid crystal, so that light is split and different lights reach left and right eyes. Therefore, when a right-eye image and a left-eye image are displayed on the display device, the user's eyes see the corresponding images and the user feels as if the image is three-dimensionally displayed. That is, under the control of the control unit 210, the display device performs a general 2D display operation in a 2D display mode by not driving the switch liquid crystal and the optical parallax barrier and driving only the display device.

In addition, the control of the control unit 210, the display device performs a 3D display operation in a 3D display mode by driving the switch liquid crystal, the optical parallax barrier, and the display device.

On the other hand, the display device may include at least one of a liquid crystal display (LCD), a thin film transistor-liquid crystal display (TFT LCD), an organic light-emitting diode (OLED), a flexible display, and a 3D display. Some of those displays may be configured in a transparent-type or transmission-type so that the user can view the outside therethrough. This may be called a transparent display, and a representative example of the transparent display is a transparent OLED (TOLED). A rear structure of the display unit may also be configured in a transmission-type structure. Due to such a structure, the user can view an object located in the rear of a terminal body through a region of the terminal body occupied by the display unit.

Tow or more display units may be provided according to an implementation type of the terminal 200. For example, a plurality of display units may be separately or integrally disposed on one surface of the terminal 200, or may be disposed on different surfaces of the terminal 200.

In case where the display unit and a sensor (hereinafter, referred to as a “touch sensor”) detecting the touch action form a mutual layer structure (hereinafter, referred to as “touch screen”), the display unit may also be used as an input device as well as the output device. The touch sensor, for example, may have a form of a touch film, a touch sheet, or a touch pad.

The touch sensor may be configured such that a pressure applied to a specific portion of the display unit or a change of an electrostatic capacitance occurring at a specific portion of the display unit is converted into an electric input signal. The touch sensor may be configured to detect a touch pressure as well as a touch position and a touch area.

When there is a touch pressure with respect to the touch sensor, a corresponding signal(s) is(are) transmitted to a touch controller (not illustrated). The touch controller processes the signal(s) and transmits corresponding data to the control unit 210. Therefore, the control unit 210 can determine which region of the display unit is touched.

A proximity sensor may be disposed in an inner region of the terminal 200 surrounded by the touch screen, or may be disposed around the touch screen. The proximity sensor refers to a sensor that detects the presence or absence of an object approaching a predetermined detection surface or an object existing near the sensor by using an electromagnetic force or infrared light, without mechanical contact. The proximity sensor has a longer lifespan and higher utilization than a contact sensor.

Examples of the proximity sensor includes a transmission-type photoelectric sensor, a direct reflection-type photoelectric sensor, a mirror reflection-type photoelectric sensor, a radio frequency oscillation-type proximity sensor, an electrostatic capacitance type proximity sensor, a magnetic-type proximity sensor, an infrared proximity sensor. In case where the touch screen is an electrostatic type, the touch screen is configured to detect the proximity of the pointer from the change of the electric field according to the proximity of the pointer. In this case, the touch screen (touch sensor) may be classified as the proximity sensor.

Hereinafter, for convenience of description, the action that the pointer is approached while not contacting the touch screen and thus the pointer is recognized as being located on the touch screen is referred to as “proximity touch”, and the action that the pointer is actually contacted on the touch screen is referred to as “contact touch”. The position where the proximity touch of the pointer occurs on the touch screen refers to a position corresponding vertically to the touch screen when the pointer performs the proximity touch.

The proximity sensor detects the proximity touch and the proximity touch pattern (for example, a proximity touch distance, a proximity touch direction, a proximity touch speed, a proximity touch time, a proximity touch position, and a proximity touch movement state). Information corresponding to the detected proximity touch operation and the proximity touch pattern may be displayed on the touch screen.

The sound output module may output audio data received from the communication unit in a call signal receive mode, a call mode, or a record mode, a voice recognition mode, and a broadcasting receive mode, or may output audio data stored in the data storage unit 250 to be described below. The audio output module may output audio signals related to functions performed in the terminal 200 (for example, call signal reception sound, message reception sound, etc.). The sound output module may include a receiver, a speaker, and a buzzer.

The alarm unit outputs a signal for notifying an event occurrence of the terminal 200. Examples of events occurring in the terminal 200 include a call signal reception, a message reception, a key signal input, and a touch input. The alarm unit can also output a signal for notifying an event occurrence by methods other than video signals or audio signals, for example, by way of vibration. The video signals or audio signals may be output through the display unit or the audio output module. Therefore, in this case, the display unit and the audio output module may be classified as a type of the alarm unit.

The haptic module generates a variety of haptic effects the user can feel. A representative example of the haptic effect generated by the haptic module is a vibration. The intensity and pattern of the vibration generated by the haptic module can be controlled. For example, different vibrations may be output in combination or may be output in sequence.

The data storage unit 250 may store a processing and control program of the control unit 210, and may perform a function of temporarily storing input/output data (for example, history, position information, and time of the OTP). The data storage unit 250 may also store frequency of each data. Also, the data storage unit 250 may store data related to the vibration of sound of various patterns output when the touch is input on the touch screen. Also, the data storage unit 250 stores a web browser that displays a 3D or 2D web page according to the present invention. The data storage unit 250 may include a storage medium of at least one type of a flash memory type, a hard disk type, a multimedia card type, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The terminal 200 may operate in relation to a web storage that performs the storage function of the data storage unit 250 on the Internet.

The interface unit 260 serves as a passage of all external devices connected to the terminal 200. The interface unit 260 may receive data from the external device, may receive power and transmit the power to each component of the terminal, or may transmit internal data of the terminal 200 to the external device. For example, the interface unit 260 may include a wired/wireless headset port, an external charger port, a wired/wireless data port, a memory card port, a port for connecting a device with an identification module, an audio input/output (I/O) port, and an earphone port.

Under the control of the control unit 210, the power supply unit 270 supplies receives external power and internal power and supplies power necessary for the operation of each component.

An OTP generation method using virtual input means according to one aspect of the present invention includes a reference information generating step S10, an identity determining step S20, and an OTP generating step S30.

In one aspect of the present invention, in the reference information generating step S10, reference information is generated by the reference information generation unit 110. The reference information is information of one or more selected from the group consisting of color, sound, symbol, image, and vibration. The identity to the identification information to be described below can be determined using the reference information.

In the identity determining step S20, it is determined whether the reference information is identical to the identification information. The reference information and the identification information are the same information and are different in arrangement. When reference information and identification information of a specific position are identical to each other, an OTP is generated through the OTP generating step S30 to be described below. When the reference information and the identification information are different from each other, an OTP is generated using the initial value.

In the OTP generating step S30, when the reference information and the identification information are identical to each other, a value corresponding to indication information is generated as the OTP by the OTP generation unit 130.

In one embodiment of the present invention, the reference information is generated, and the reference information and the identification information are compared with each other. When identical, the value corresponding to the indication information is generated as the OTP by the OTP generation unit 130. When not identical, the initial value is formed as the OTP, and it is possible to generate the OTP in which the OTP of the value corresponding to the indication information and the OTP having the initial value as it is are combined.

According to the present invention, it is possible to prevent damages of users in relation to password hacking or leakage through the use of one-time (variable) password, thereby achieving user authentication with an easier mind.

In addition, since a separate OTP generator is not required, the user can use the password simply. Since the OTP can be generated using the OTP generation apparatus, costs can be reduced.

Furthermore, even when the user password leaks out, the user can use a password with an easier mind because the password is regenerated with reference to the identification information known to only the user.

It is obvious to those skilled in the art that the present invention can be embodied in other specific forms without departing from the scope and essential features of the present invention.

1. A one-time password (OTP) generation apparatus (10) for user authentication, comprising:
a reference information generation unit (110) configured to generate reference information; and
an OTP generation unit (130) configured to generate a value corresponding to indication information as an OTP when the reference information and identification information are identical to each other.

2. The OTP generation apparatus of claim 1, wherein the OTP generation unit (130) generates an OTP with reference to an initial value.

3. The OTP generation apparatus of claim 2, wherein the initial value is a password that is previously determined for user authentication.

4. The OTP generation apparatus of claim 2, wherein when the reference information and the identification information are different from each other, the OTP generation unit (130) sets the initial value as an OTP value.

5. The OTP generation apparatus of claim 1, wherein the reference information generation unit (110) generates the reference information by a user's designation.

6. The OTP generation apparatus of claim 5, wherein the reference information is generated from a position, order or other terminal designated by a user.

7. The OTP generation apparatus of claim 1, wherein the reference information generation unit (110) includes a table generation unit (111) configured to generate a table of which columns is capable of being designated by a user, and information corresponding to the column of the table designated by the user is generated as the reference information.

8. The OTP generation apparatus of claim 1, wherein the reference information and the identification information are same type.

9. The OTP generation apparatus of claim 1, wherein the reference information and the identification information are information of one or more selected from the group consisting of a color, a sound, a symbol, an image, and a vibration.

10. The OTP generation apparatus of claim 1, wherein the indication information is direction indication information that indicates a specific direction.

11. The OTP generation apparatus of claim 10, wherein when the reference information and the identification information are identical to each other, an initial value is changed to a value of a direction corresponding to the direction indication information and is then generated as the OTP.

12. The OTP generation apparatus of claim 1, wherein when the OTP generation apparatus (10) is tilted or shaken the value corresponding to the indication information is a tilt or shaking value that is generated by a tilt and shaking detection unit (150).

13. The OTP generation apparatus of claim 1, further comprising a virtual input means generation unit (170) configured to generate virtual input means, wherein the generated OTP is input through the virtual input means.

14. The OTP generation apparatus of claim 13, wherein the virtual input means is a QWERTY keyboard or a virtual key pad.

15. The OTP generation apparatus of claim 13, wherein the value corresponding to the indication information is a pattern value, a repetitive input value of a specific value, or a continuous input value of a specific value, each of which is input through the virtual input means.

16. The OTP generation apparatus of claim 10, wherein the value corresponding to the indication information is a previously determined value.

17. The OTP generation apparatus of claim 1, wherein the OTP generation apparatus (10) is a server or user terminal (100).

18. The OTP generation apparatus of claim 1, wherein the reference information and the identification information are changed at every request for user authentication.

19. The OTP generation apparatus of claim 1, wherein when incorrect OTP is input three or more times, the reference information, the indication information, and the identification information are changed.

20. An OTP generation method for user authentication, comprising:
generating reference information by a reference information generation unit (110) (S10);
determining whether the reference information and identification information are identical to each other (S20); and
generating, by an OTP generation unit (130), a value corresponding to indication information as an OTP when the reference information and identification information are identical to each other (S30).

21. The OTP generation apparatus of claim 12, wherein the value corresponding to the indication information is a previously determined value.

22. The OTP generation apparatus of claim 15, wherein the value corresponding to the indication information is a previously determined value.
